(19) United States
(12) Patent Application Publication
(10) Pub. No.: US 2004/0056127 A1
(43) Pub. Date: Mar. 25, 2004

(54) Shredder for sheet material having an improved feeding mechanism

(76) Inventor: David Mead, Droitwich Spa (GB)

Correspondence Address: Kirschstein, Ottinger, Israel & Schiffmiller, P.C., 489 Fifth Avenue, New York, NY, 10017-6105, US

(21) Appl. No.: 10/603,127

(22) Filed: Jun. 24, 2003

(30) Foreign Application Priority Data
Jun. 28, 2002 (GB) GB 0214954.0

(51) Int. Cl. B02C 23/26

(52) U.S. Cl. 241/57; 241/60

(57) ABSTRACT

A shredder for sheet material comprises a shredding mechanism and an air feeding mechanism. Conveniently the air feeding mechanism comprises a vacuum pump. An air flow path extends through the shredding mechanism of the shredder and the pump is disposed after the shredding mechanism in the air flow path. The air feeding mechanism comprises a collection device for collecting shredded particles, which may include a permeable bag.

### BACKGROUND TO THE INVENTION

This invention relates to improvements in feeding mechanisms. In particular, this invention relates to improvements in feeding mechanisms for sheet materials, such as paper, which are fed into a device, such as a shredder, for processing therein. These mechanisms are described hereinafter in relation to paper, but it will of course be appreciated that they could be used with many different types of sheet material.

### DESCRIPTION OF THE PRIOR ART

Typically, in shredders, cutting discs are provided which themselves intermesh. Since these are mounted on rollers which rotate in opposite directions, they provide a nip into which paper can be fed, and draw paper through the shredder without the need for any further feeding mechanism. There are shredders, however, which operate on a different principle, for example the shredder described in pending U.K. Patent Application Serial No. 0210599.7, in which sheet material is shredded using rectilinear punches.

Typically feed rollers are used in such shredders to feed the paper into the shredding mechanism. The rollers are situated just before the shredding mechanism in the feed path of the paper, but, even so, when the edge of the paper leaves the rollers there is a small amount of paper left above the shredding mechanism which is not fed through. This problem can be minimized by siting the feed rollers as close as possible to the shredding mechanism, and by using gravity to assist the feed of the last part of the paper, but these solutions are not wholly satisfactory.

There is, therefore, a need for a continuous feed mechanism which can feed an entire piece of paper through such mechanisms.

### SUMMARY OF THE INVENTION

According to this invention there is provided a shredder for sheet material comprising a shredding mechanism and an air feeding mechanism.

Use of an air feeding mechanism enables the sheet material to be fed completely through the shredding mechanism. The mechanism also has advantages in that the sheet material tends to stretch or crinkle less than when using a conventional mechanism. The air feeding mechanism also draws dust generated by the shredding process through the shredder where it is less likely to present a health hazard.

Preferably the air feeding mechanism comprises a suction means, which conveniently comprises a vacuum pump. Conveniently the pressure generated by the suction means is greater than 0.5 bar, preferably greater than 1 bar.

Conveniently an air flow path extends through the shredding mechanism, the suction means being preferably disposed after the shredding mechanism in the air flow path.

Preferably the air feeding mechanism comprises a collection means for collecting shredded particles, which conveniently comprises a permeable bag. Conveniently the collection means, or a further collection means, is also suitable for collecting dust generated during the shredding process.

Preferably the air feeding mechanism comprises a plurality of intermediate chambers disposed in the air flow path after the shredding mechanism and before the collection means.

Preferably the shredder further comprises feed rollers, which are conveniently located in the air flow path before the shredding mechanism. These assist the initial feeding of the sheet material.

### BRIEF DESCRIPTION OF THE DRAWINGS

An embodiment of the invention will now be described, by way of example only, with reference to the accompanying drawing in which:

FIG. 1 shows schematically a section view of one embodiment of a shredder according to this invention.

### DESCRIPTION OF THE PREFERRED EMBODIMENT

The shredder 10 comprises a shredding mechanism 12, an air feeding mechanism 14 and infeed rollers 16. In this embodiment the shredding mechanism comprises a plurality of punch members 18 positioned in die members 20. The mechanism is generally as described in pending U.K. Patent Application Serial No. 0210599.7, and only the feeding mechanisms will be described further herein.

Air feeding mechanism 14 comprises a vacuum pump 22 which is connected by tubes 24 to a collection chamber 26 which contains a paper bag 28 which functions as a collection bag for shredded particles. Tubes 30 connect the collection chamber to two smaller chambers, manifolds 32, 34. Each manifold 32, 34 is arranged at the outlets of aperture channels 36, 38, which receive punch members 18 when in their advanced position.

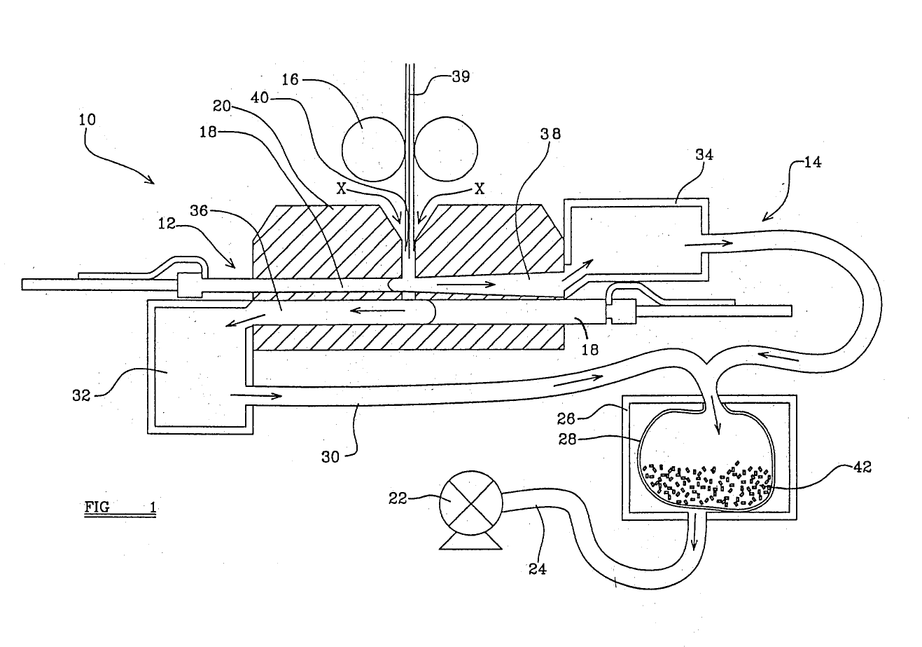

The air flow path through the machine will now be described. Air is drawn as shown by arrows X through a feed channel 40 in the die members 20, which also acts as an inlet for paper 39 being fed to the shredding mechanism 14. From the feed channel 40, when the punch members 18 are in their retracted position, as shown in FIG. 1, air flows through the aperture channels 36, 38 to the manifolds 32, 34. These manifolds 32, 34 provide a convenient way of connecting the many aperture channels 36, 38 in the die members 20. Air flows from the manifolds 32, 34 to the paper bag 28 in the collection chamber 26, and through the paper bag 28 to the vacuum pump 22.

When the punch members 18 are in their advanced position they extend past the feed channel 40 into the aperture channels 36, 38 and substantially prevent air flow through the air feeding mechanism 14.

To operate the shredder 10 a plurality of paper sheets 39 is fed into the shredding mechanism through infeed rollers 16. These rollers 16 provide the initial feed, transporting the leading edge of the paper to the feed channel 40. Once in the feed channel 40 the paper is subjected to a degree of suction pressure, and the high velocity of air in the infeed channel 40 draws the paper along the air path. The velocity of the air increases as the number of sheets of paper increases since this makes the infeed channel 40 narrower and thus the effectiveness of the air feeding mechanism 40 is retained despite the larger load.

When the paper reaches the shredding mechanism 14 it is shredded, generally as described in U.K. Patent Application Serial No. 0210599.7. A plurality of small paper particles 42 is thereby generated, which are carried along the air flow path through the aperture channels 36, 38, the manifolds 32, 34 and the tubes 30 to the collection chamber 26. These then collect in the paper bag 28. Once full the paper bag 28 may be easily emptied, and the shredded particles 42 disposed of.

The suction generated by the air feeding mechanism 14 draws the paper through the shredder 10 and acts as a convenient way of collecting shredded particles 42. The air feeding mechanism can, as shown in the embodiment above, be supplemented by infeed rollers 16, but can also function as the sole feeding mechanism. Unlike infeed rollers the air feeding mechanism does not tend to crinkle or stretch the paper, but provides a smooth and effective feed.

Although described above in relation to a shredder it will be apparent that the air feeding mechanism outlined herein could be used in other devices, for example a printer, where sheet material must be fed past a processing head.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

I claim:

1. A shredder for sheet material, comprising: a shredding mechanism and an air feeding mechanism.

2. The shredder according to claim 1, wherein the air feeding mechanism comprises a suction means.

3. The shredder according to claim 2, wherein the suction means comprises a vacuum pump.

4. The shredder according to claim 2, wherein the suction means generates a pressure which is greater than 0.5 bar.

5. The shredder according to claim 4, wherein the pressure generated by the suction means is greater than 1 bar.

6. The shredder according to claim 2, wherein an air flow path extends through the shredding mechanism, and wherein the suction means is disposed after the shredding mechanism in the air flow path.

7. The shredder according to claim 1, wherein the air feeding mechanism comprises a collection means for collecting shredded particles.

8. The shredder according to claim 7, wherein the collection means includes a permeable bag.

9. The shredder according to claim 7, wherein the collection means is also operative for collecting dust generated during the shredding process.

10. The shredder according to claim 7, wherein the air feeding mechanism comprises a plurality of intermediate chambers disposed in the air flow path after the shredding mechanism and before the collection means.

11. The shredder according to claim 6, and feed rollers located in the air flow path before the shredding mechanism.
